(19) United States
(12) Patent Application Publication
(10) Pub. No.: US 2019/0340720 A1
(43) Pub. Date: Nov. 7, 2019

(54) Methods and Systems for a Rearrangeable Task Distribution System

(71) Applicant: DISH Network L.L.C., Englewood, CO (US)

(72) Inventors: Mark Schuster, Castle Rock, CO (US); Greg Goldey, Castle Pines, CO (US)

(21) Appl. No.: 15/971,818

(22) Filed: May 4, 2018

(51) Int. Cl. G06Q 90/00

(52) U.S. Cl. CPC G06Q 90/00; G06Q 10/06313

(57) ABSTRACT

Various arrangements are presented for providing a physical action plan. A physical grid may be created that includes rows and columns that define cells. The columns may include a first column indicative of a plurality of initiatives. The columns of the grid may include a second column indicative of a ranking of the initiatives. On the physical grid, project tasks for at least some cells may be defined. Project cards may be created. Each project card may be attachable to and removable from the physical grid. Each project card may be sized to match a size of a cell size of the plurality of cells. Each project card may indicate a different project task. The project cards may be attached to the physical grid such that each project card is attached to and overlays a cell of the physical grid. The project task of the project card and the underlying project task of the cell match to insure traceability of each project assignment.

### BACKGROUND

Large-scale planning events can be expensive for the organizing entity. For example, a large engineering company may have hundreds of engineers divided into smaller teams that are working on individual tasks toward a larger goal. Occasionally, an entity may assemble all or a large portion of its workforce to determine how various tasks are going to be divided up for a coming time. A way of visually representing and prioritizing all of the required tasks involved may greatly increase efficiency. For instance, many tasks may require collaboration between teams or may be dependent on another task being completed first. An efficient visual representation that can be easily updated may facilitate communication between teams.

### SUMMARY

Various embodiments are described related to a method for creating a physical action plan. In some embodiments, a method for creating a physical action plan is described. The method may include creating a physical grid comprising a plurality of rows and a plurality of columns such that the plurality of rows and the plurality of columns may define a plurality of cells. The plurality of columns of the physical grid may include a first column indicative of a plurality of initiatives. Each initiative may include multiple project tasks. The plurality of columns of the physical grid may include a second column indicative of a ranking of the plurality of initiatives. The method may include defining, on the physical grid, a plurality of project tasks for at least some cells of the plurality of cells. The method may include creating a plurality of project task cards. Each project task card of the plurality of project task cards may be attachable to and may be removable from the physical grid. Each project task card of the plurality of project task cards may be sized to match a size of a cell size of the plurality of cells. Each project task card of the plurality of project task cards may indicate a different project task of the plurality of project tasks. The method may include attaching the plurality of project task cards to the physical grid such that each project task card of the plurality of project task cards may be attached to and may overlay a cell of the physical grid. The project task of the project task card and the project task of the cell may match.

Embodiments of such a method may include one or more of the following features: The method may include adding a team identifier to a project task card of the plurality of project task cards. The method may include adding the team identifier to a cell of the physical grid over which the project task card may have been attached. The method may include removing the project task card from the physical grid. The method may include altering each column in which a project task card may be attached to identify a priority of a project task of the project task card relative to other project tasks within a same row of the plurality of rows. Creating the plurality of project task cards may include selecting a color for each project task card of the plurality of project task cards based on a category of a project task of the project task card. The method may include creating a plurality of initiative priority cards. Each initiative priority card of the plurality of initiative priority cards may be removable from and may be attachable to the physical grid. Each initiative priority card of the plurality of initiative priority cards may be sized to match a cell size of the second column. Each initiative priority card of the plurality of initiative priority cards may indicate a different priority. The method may include altering each row of the plurality of rows in which an initiative priority card may be located to identify a priority of an initiative of the plurality of initiatives relative to other initiatives of the plurality of initiatives. The plurality of project task cards each may include a removable adhesive.

In some embodiments, an action plan management system is described. The system may include a physical grid comprising a plurality of rows and a plurality of columns that define a plurality of cells. The plurality of columns of the physical grid may include a first column indicative of a plurality of initiatives. The plurality of columns of the physical grid may include a second column indicative of a ranking of the plurality of initiatives. The plurality of columns of the physical grid may include multiple columns indicative of projects. Within the multiple columns indicative of projects, each cell of the plurality of cells may correspond to a particular project. The plurality of rows may include multiple rows in which each row relates one or more projects with an initiative of the plurality of initiatives. Each project task card of the plurality of project task cards may be removable from and may be re-attachable to the physical grid. Each project task card of the plurality of project task cards may be sized to match a size of the plurality of cells. Each project task card of the plurality of project task cards may indicate a particular project task that matches an indication of the particular project task indicated on the physical grid in the cell to which the project task card may be removably attached and may overlay.

Embodiments of such a system may include one or more of the following features: A team identifier may be present on a project task card of the plurality of project task cards. The team identifier may be present on the cell of the physical grid over which the project task card may have been attached. Each column of the multiple columns in which a project task card may be organized to identify a priority of a project task of the project task card relative to other project tasks within a same row of the plurality of rows. The plurality of project task cards may be colored based on a category of project task of each project task card. The system may include a plurality of initiative priority cards. Each initiative priority card of the plurality of initiative priority cards may be removable from and may be attachable to the physical grid. Each initiative priority card of the plurality of initiative priority cards may be sized to match a cell size of the second column. Each initiative priority card of the plurality of initiative priority cards may indicate a different priority. The plurality of project task cards each may include a removable adhesive.

In some embodiments, an action plan management apparatus is described. The apparatus may include a grid means comprising a plurality of rows and a plurality of columns that define a plurality of cells. The plurality of columns of the grid means may include a first column indicative of a plurality of initiatives. The plurality of columns of the grid means may include a second column indicative of a ranking of the plurality of initiatives. The plurality of columns of the grid means may include multiple columns indicative of projects. Within the multiple columns indicative of projects, each cell of the plurality of cells may correspond to a particular project. The plurality of rows may include multiple rows in which each row may relate one or more projects with an initiative of the plurality of initiatives. Each project task means of the plurality of project task means may be presentable separate from the grid means. Each project task means of the plurality of project task means may be sized to match a size of the plurality of cells. Each project task means of the plurality of project task means may indicate a particular project task that may match an indication of the particular project task indicated on the grid means in the cell to which the project task means may overlay.

Embodiments of such an apparatus may include one or more of the following features: A team identifier means may be present on a project means of the plurality of project task means. An apparatus may include a corresponding team identifier means being present on a cell of the grid means on which the project means may be presented. The apparatus may include means for altering each column of the multiple columns in which a project means may be present to identify a priority of a project task of the project task means relative to other project tasks within a same row of the plurality of rows. Creating the plurality of project task means may include selecting a color for each project task means of the plurality of project task means based on a category of a project task of the project task means. The apparatus may include a plurality of initiative priority means. Each initiative priority means of the plurality of initiative priority means may be presentable on the grid means. Each initiative priority means of the plurality of initiative priority means may be sized to match a cell size of the second column. Each initiative priority means of the plurality of initiative priority means may indicate a different priority. The apparatus may include means for altering each row of the plurality of rows in which an initiative priority means may identify a priority of an initiative of the plurality of initiatives relative to other initiatives of the plurality of initiatives. The plurality of project task means each may include a removable adhesive.

### BRIEF DESCRIPTION OF THE DRAWINGS

FIG. 1 illustrates an embodiment of a rearrangeable task distribution system.

FIG. 2 illustrates an embodiment of an abstraction of a rearrangeable task distribution system.

FIG. 3 illustrates an embodiment of a system for creating and distributing a rearrangeable task distribution system.

FIG. 4 illustrates an embodiment of a computerized interface that allows for clients to interact with a rearrangeable task distribution system.

FIG. 5 illustrates an embodiment for a method for creating a rearrangeable task distribution system.

FIG. 6 illustrates an embodiment of a method for using a rearrangeable task distribution system.

### DETAILED DESCRIPTION

An efficient visual representation that can be used with a small or large crowd of people may involve a grid being populated with various initiatives and associated priorities. These initiatives may be large-scale projects that each involve some number of sub-tasks being performed. The priority of these initiatives may vary relative to each other. The sub-tasks may be referred to as project tasks. Project tasks may be linked with a particular initiative, but may vary in priority relative to other project tasks linked with the same particular initiative.

A physical arrangement may be created in which a grid is created having a first column dedicated to an initiative priority. A second adjacent column may be devoted to details about a given initiative, such as the name of the initiative and a unique identifier. While the second column may include an identifier affixed directly to the grid, the first column may have initiative priorities attached using detachable and re-attachable cards. This arrangement allows for initiative priorities to be reordered, such as during a meeting or conference.

Some number of additional columns may be present for project tasks. The columns of project tasks can include project tasks linked with the various initiatives. Each initiative may have one or more linked project tasks. Cells of the grid in these additional columns may be populated with project task identifiers and a project task name. Affixed over these cells of the grid may be a matching card that also indicates the project task identifier and the project task name. As project tasks are divided out among groups of persons (e.g., engineering teams, coding teams, etc.), a team may receive the card affixed over a cell of the grid. The team's name may be physically added to the underlying cell of the grid. As such, a grid is created that indicates to which team each project task is assigned and each team retains physical cards that indicate the project task to which they have been assigned. By using cards that are a different color from each other to distinguish different types of project tasks and a different color from the underlying grid, it can be easy to visualize the different types of project tasks to be completed and which project tasks are yet to be assigned.

Such an arrangement can have significant technical benefits. In large meetings, such as those where it is not desirable to have persons using computers, it may be desirable to create a single object that large numbers of persons can easily view to determine the tasks assigned to other teams. Further, to ensure each team is aware of which tasks they are responsible for, it may be useful to have each team have a physical takeaway as the project tasks are assigned and when the meeting ends. Such a system allows for the creating of a large, centralized display of project task assignments and relative priorities while providing individual teams with physical takeaways that name and identify the one or more project tasks that have been assigned to the team. Such a system may further benefit collaboration, especially when one project task is dependent on another project task. The centralized grid may allow a first team to identify which other team is assigned to a related project task so that a sequence of work can be properly coordinated and deliverables understood. Such a system may further allow for teams to sequence identified tasks to derive a coordinated plan for both deliverables and dates to support the larger initiative.

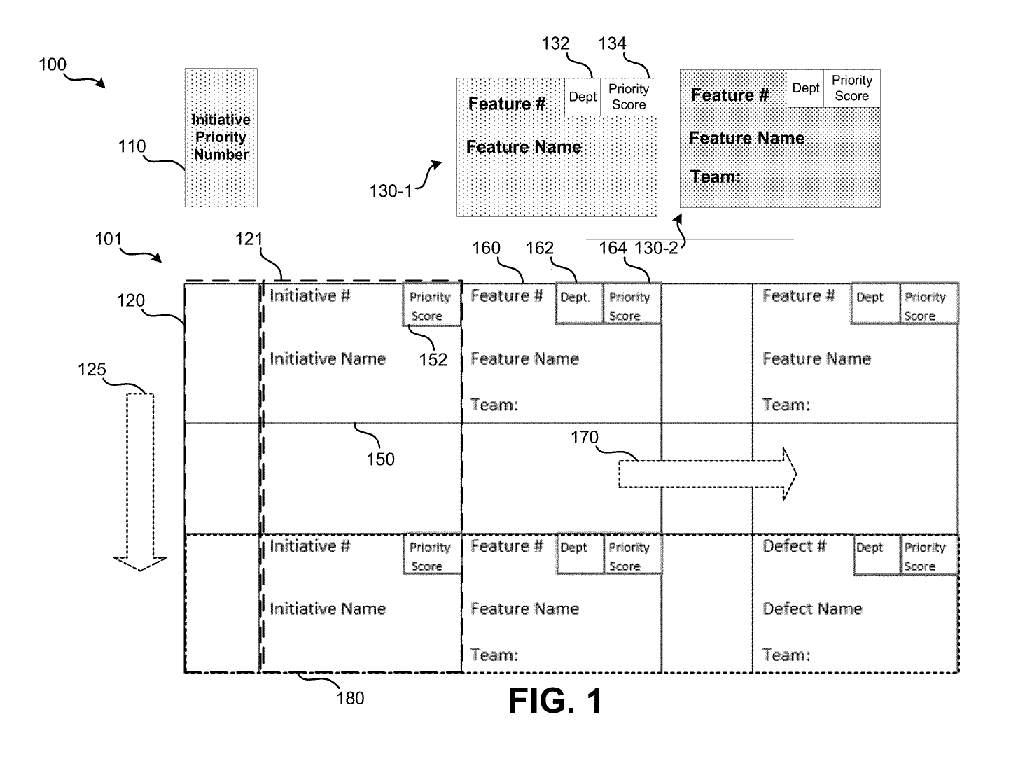

Further detail regarding such an arrangement is provided in relation to the figures. FIG. 1 illustrates an embodiment of a rearrangeable task distribution system. Rearrangeable task distribution system 100 may be implemented physically, such as using a printed grid with detachable and re-attachable cards. Rearrangeable task distribution system 100 may alternatively be implemented in a computerized environment such that the grid is presented as a user interface and virtual “cards” may be presented on the grid, giving the impression of the virtual cards being overlaid. Grid 101 may include multiple rows and multiple columns which define multiple cells.

Columns 120 and 121 may be used to define initiatives and relative initiative priorities. An initiative can refer to a large-scale project that has many subprojects or project tasks linked with it. For example, an initiative can refer to a product produced by a company which has many subprojects or project tasks associated with it that need to be performed prior to bringing the product to market or releasing it to the public. Initiative cell 150 includes data that may be printed or otherwise affixed directly to grid 101 that includes information about an initiative. Such data may include: an initiative name, an initiative identifier, and priority score 152. An initiative name may represent a word or phrase used to identify the initiative, such as a product's name or internal code name. An initiative identifier may be a unique numerical or alphanumeric identifier that distinguishes the initiative from other initiatives present on grid 101. A priority score, such as priority score 152, may identify a numerical value assigned to a particular initiative. The priority score may indicate an overarching priority assigned to a particular initiative on a given scale, such as 1 to 100.

Adjacent to column 121 may be column 120. Column 120 may include blank cells. Multiple initiative priority cards, such as initiative priority card 110, may be removably affixed to the cells of column 120. Initiative priority cards, such as initiative priority card 110, may specify a number that is unique from other initiative priority numbers. In some embodiments, initiative priorities increase consecutively from one. Thus, an initiative assigned an initiative priority of one is the highest priority initiative. An initiative priority of two would be the second-highest priority initiative. By initiative priority cards being removably attached to cells in column 120, the relative priorities of initiatives in column 121 may be adjusted by a person. While priority scores, such as priority score 152, represent an overarching priority for an initiative, the initiative priority for column 120 can represent a priority for initiatives at a given meeting or event. Therefore, while a first initiative may have higher priority for an entity overall, a second initiative may be higher priority for being addressed at a given meeting. For example, while on grid 101 initiatives may be added in a descending order of priority as indicated by arrow 125, these priorities may be adjusted by rearranging initiative priority numbers during a meeting.

Multiple columns may be adjacent to columns 120 and 121 of grid 101. The number of columns present may be determined based on the initiative that has the largest number of linked project tasks. Therefore, for example, if the initiative of cell 150 has five linked project tasks, five additional columns may be present such that each of these five project tasks can be printed in the same row as the initiative of cell 150.

Project task cell 160 illustrates an example of a cell devoted to a project task. Each project task cell, such as project task cell 160, may include: a feature identifier (or project task identifier), a feature name (or project task name), a spot to enter a team name at a later time, department 162, and priority score 164. The feature identifier may be a numerical or alphanumeric identifier that uniquely identifies a project task from each other feature present on grid 101. The feature name may indicate a name by which the project task is known. Department 162 may indicate a known department to which work to be performed on the feature will be assigned. Within a department, such as department 162, may be multiple teams. The specific team to which a feature is to be assigned to work on may not be known at the time grid 101 is created. As an example of this, while it may not be known which team will perform a project task, but given that a project task is software-related, it may be easily determined that the software development department would handle the project. The spot to enter a team name may not be completed at the time grid 101 is created; rather this information may be added onto grid 101 during a meeting when an assignment takes place. Priority score 164 may identify a numerical value assigned to a particular initiative. The priority score may indicate an overarching priority assigned to a particular initiative on a given scale, such as 1 to 100. In some embodiments, additionally or alternatively, a value may be present for each project task or feature that estimates a number of man-hours needed to complete the project task. Therefore, if a particular project task is assigned to a particular team, it can be assumed that the team will need to expend the indicated number of man-hours to complete the project task.

The indicated project task information may be printed directly onto grid 101 in various project task cells. Each of the project tasks linked with a particular initiative may be listed in the same row as the initiative, such as indicated in row 180. Project tasks may be added to a row in a descending order of priority, such as indicated by arrow 170.

For each project task, a separate project task card may be created. In a physical embodiment, this card may be made from paper or card stock and may include an adhesive that allows for the card to be attached to and detachably removed from grid 101. In other embodiments, some other form of detachable and re-attachable fastener may be used, such as a hook-and-loop fastener. A project card, such as project task card 130-1 or project task card 140-2, may be created for each project task cell present on grid 101. The project card may include all or some of the same information as the matching project task cell. For example, if project task card 130-1 corresponds to project task cell 160, the feature identifier, feature name, department, and priority score may match between project task card 130-1 and project tasks cell 160. In some embodiments, project task cards contain a space for a team name to be added; in other embodiments, there is no space for a team name. Department name 132 may be added to project task cards, such as project task card 130-1. While a team name may not be known at the time of creation, department name 132 may be known. Similarly, a priority score, such as priority score 134 may be added to project task cards, such as project task card 130-1. Department 132 and priority score 134 may match a similar department and priority score of a cell of grid 101 to which project task card 130-1 is attached.

Project task cards may be sized to match a cell size of project task cells of grid 101. Similarly, initiative priority cards may be sized to match the size of cells in column 120. The size of project task cards and initiative priority cards may vary from each other.

Project task cards may be different colors, such as illustrated by project task cards 130-1 and 140-2, to visually illustrate the type of project task. For instance, for a software project, project tasks associated with an entirely new software feature may be a different color than project tasks linked with correcting a software bug. A different color may be used for initiative priority cards, such as initiative priority card 110. A different color may also be used to identify architectural work from development work. In some embodiments, the background of grid 101 is a different color from any of the colors of the project task cards. For instance, the background of grid 101 may be white, while colors such as yellow, blue, green, and red may be used for the colors of project task cards. Therefore, when a project task card of project task cards 130 is removed from grid 101, it may be obvious since a different color, such as white, is revealed. Further, it may be easy to identify remaining project task cards attached with grid 101, since the remaining project task cards will be in a color other than the grid's background color.

Each project task card, such as project task card 130-1 and project task card 140-2, may be affixed to grid 101. Each project task card may be overlaid on the corresponding project task cell of grid 101. Therefore, if project task card 130-1 matches project task cell 160, project task card 130-1 may be attached and overlay project task cell 160. This arrangement may obscure the project task cells from view while the project task cards are affixed to grid 101.

When a project task is assigned to individual teams of employees, agents, engineers, or other groupings of people (or individual persons), the associated project task card may be removed from grid 101 and provided to the team or person who has received the assignment. The team's name or person's name may be added directly to the underlying cell or grid 101 such that the grid identifies the assigned team and project task. Accordingly, after assignments at the meeting have been completed, each team that received an assignment will have one or more project task cards as a takeaway and the grid will be completed with the team or person names that are responsible for each project task allowing teams to establish any agreed to target dates.

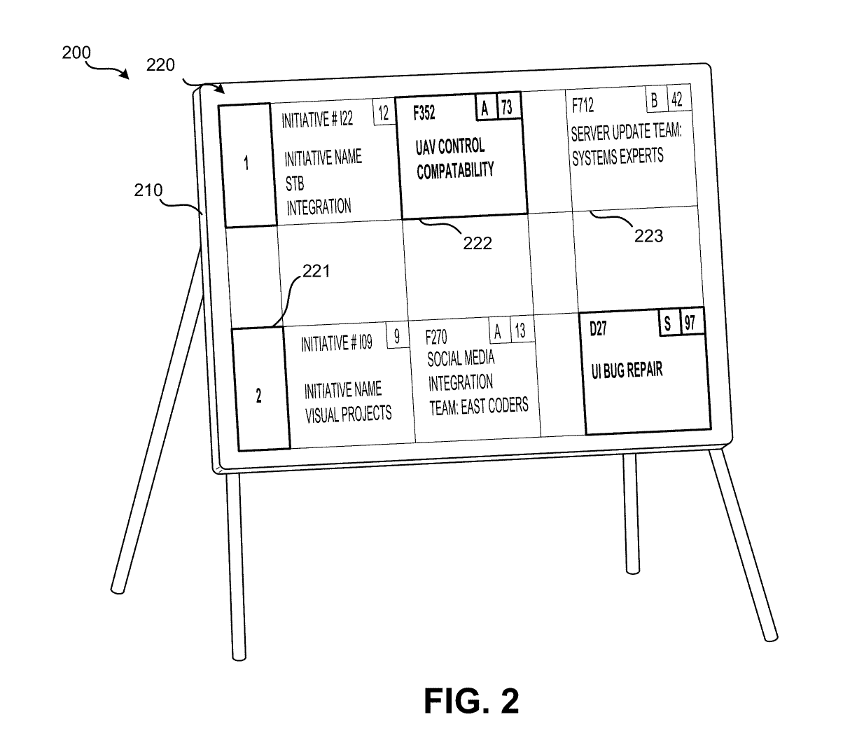

FIG. 2 illustrates an embodiment 200 of an abstraction of a rearrangeable task distribution system. In embodiment 200, presentation stand 210 is being used to display printed grid 220. Grid 220 represents an embodiment of a grid, such as grid 101. Upon grid 101, multiple cards are removably attached, such as initiative priority card 221 and project task card 222. Project task card 222 has yet to be removed and provided to a team or person. However, project task cell 223 has had an overlaid project task card removed and a team to which the project task has been assigned has been printed on project task cell 223.

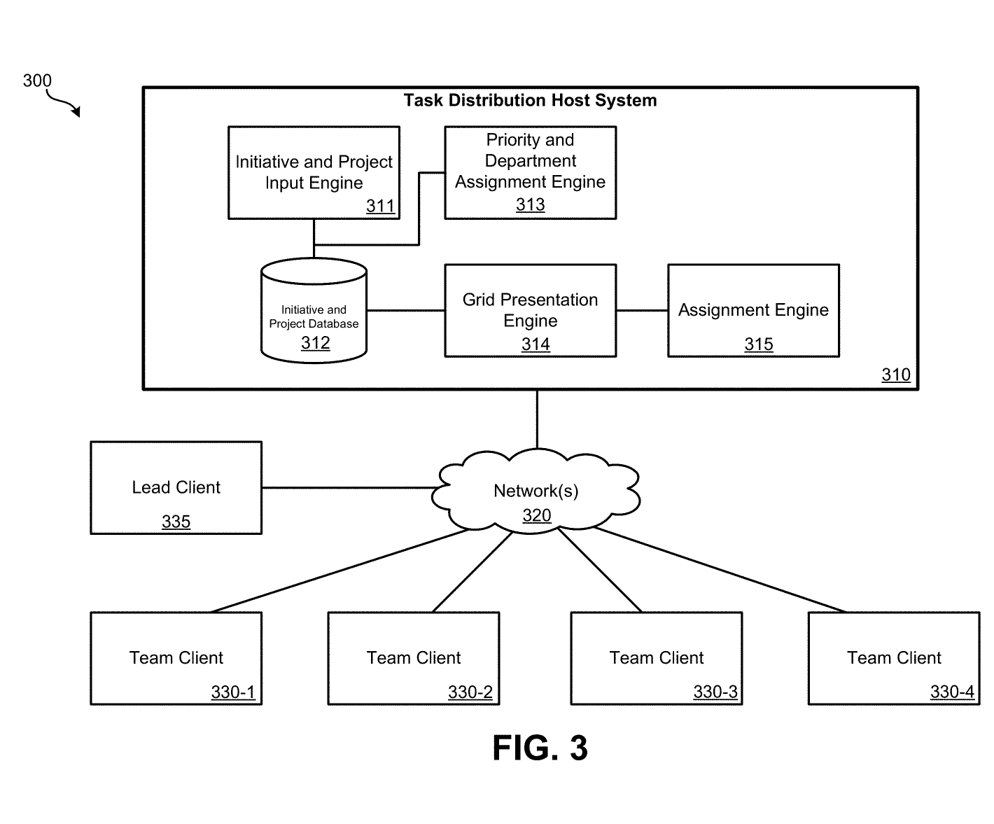

In some embodiments, rather than a physical arrangement that allows for project tasks to be assigned in a non-computerized environment, a task distribution system can be implemented using a computerized arrangement. FIG. 3 illustrates an embodiment of a rearrangeable task distribution system 300. System 300 may include: task distribution host system 310, one or more networks 320, lead client system 335, and team client systems 330. Task distribution host system 310 may include: initiative and project input engine 311, initiative and project database 312, priority and department assignment engine 313, grid presentation engine 314, and assignment engine 315.

Lead client system 335 may indicate a computerized system through which an administrator or manager may initially define initiatives and project tasks that are to be completed. Lead client system 335 may access task distribution host system 310 through one or more networks 320, which may include the Internet and/or one or more public or private networks. Through initiative and project input engine 311, a manager or administrator may define multiple initiatives and multiple project tasks for each initiative. Initiative and project input engine 311 may assign each initiative and each project task a unique identifier or may receive such an identifier from lead client system 335. The manager or administrator may use priority and department assignment engine 313 to assign relative priorities to each initiative and each project task. Further, the manager administrator may assign a particular department to which the project tasks are likely to be assigned. In some embodiments, the administrator or manager may also assign a man hour value (or some other resource allocation value) to each project task. The manager administrator may, via priority and department assignment engine 313, have the option to reassign priorities of initiatives and project tasks for those specific initiatives. The created initiatives and associated project tasks may be stored to initiative and project database 312. In some embodiments, lead client system 335 may also be used to access previously defined initiatives and project tasks from initiative and project database 312. For example, at a previous time initiatives may already have been defined and project tasks which have not been completed may be stored in initiative and project database 212. The administrator or manager may use this previous stored data and define which initiatives and project tasks should be presented at an upcoming meeting or event.

When the meeting is ready to begin, grid presentation engine 314 may present a grid that includes project task cards present over each project task in the grid, as detailed in relation to FIG. 1. The grid may be presented to lead client system 335 and each of team client systems 330. As illustrated, there are four team client systems (330-1, 330-2, 330-3, and 330-4), although it should be understood that in other embodiments fewer or greater numbers of team client systems may be present. Each team client may be permitted to select and remove project tasks from the presented grid. Alternatively, the manager administrator operating lead client system 335 may be permitted to assign project tasks to the teams using team client systems 330. In other embodiments, each team may take a turn selecting a project task presented on the grid output by grid presentation engine 314. Assignment engine 315 may track in a database (e.g., initiative and project database 312) to which team a project task is assigned, may update the grid to indicate the team name in the project task cell, may tally a total number of man-hours assigned to each team, and may track the total number of projects assigned to each team.

When a project task is assigned to a given team, the team client system linked with that team may receive a virtual project card that can be saved or printed by the linked team client system. The virtual project card may be removed from the grid, such that it appears that the project card has been removed. The grid may use a different color to indicate the cell associated with the assigned project task and may indicate the team name to which the project task has been assigned.

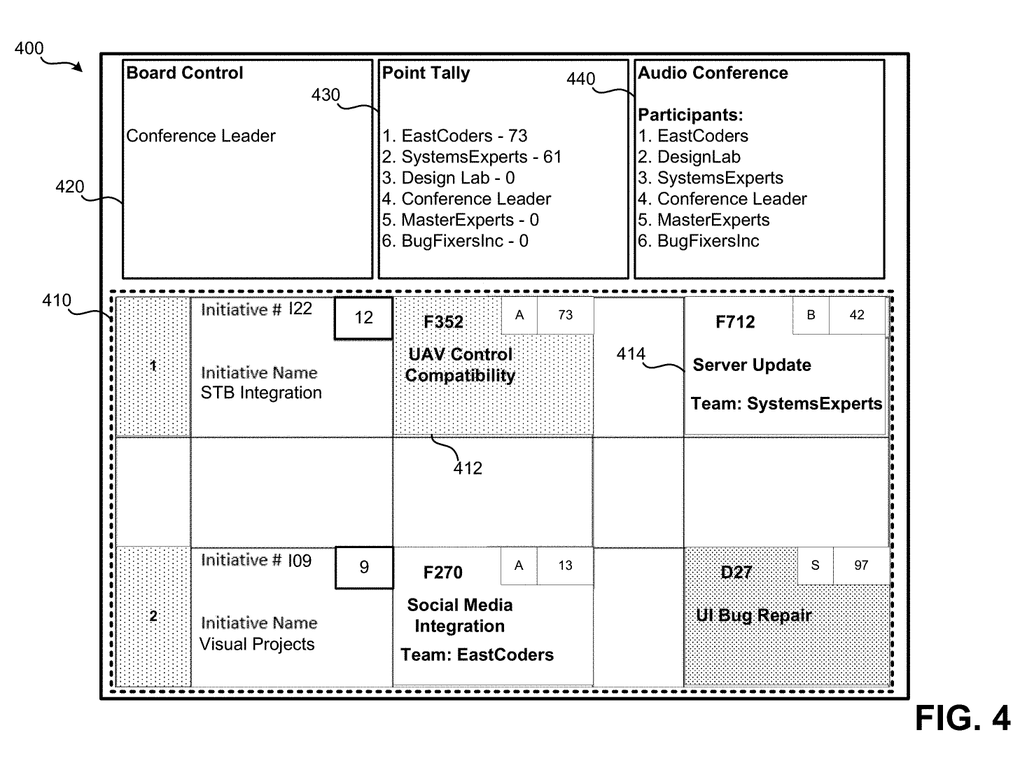

When a meeting is ready to be held, each team or representative of each team may log into task distribution host system and participate in the assignment of tasks output for presentation by grid presentation engine 314. Audio, video, and/or text-based communication may be enabled between meeting participants via task distribution host system 310, lead client system 335, and team clients 330. FIG. 4 illustrates an embodiment of an interface that may be generated by grid presentation engine 314 and presented by each of team client systems 330.

FIG. 4 illustrates an embodiment of a computerized interface 400 that allows for client systems to interact with a rearrangeable task distribution system. Interface 400 may present grid 410 which may contain information and function as detailed in relation to FIG. 1. When a virtual project card, such as virtual project card 412, is removed from grid 410, a team name to which the project task is assigned may be added and the color of the cell may be changed to represent that the virtual project card has been removed, such as shown in project task cell 414.

Interface 400 may include other elements that allow for interactions with other teams and the manager or administrator. For instance, region 420 may indicate that grid 410 is currently under the control of the conference leader. Region 430 may indicate a point tally, which can be indicative of man-hours to perform assigned project tasks. Such a tally may ensure that project tasks are evenly distributed among participating teams. Region 440 may indicate the teams that are participating in an accompanying audio and/or video conference.

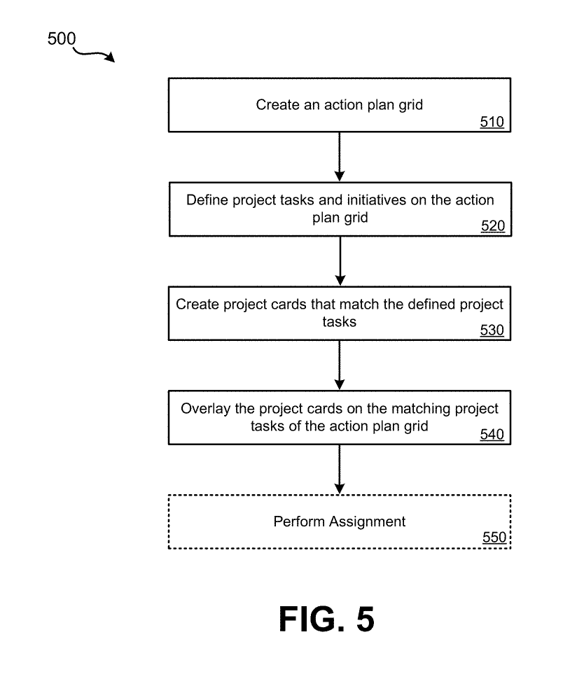

Various methods may be performed using the physical and computerized embodiments of the rearrangement task distribution systems detailed in relation to FIGS. 1-4. FIG. 5 illustrates an embodiment for a method for creating a rearrangeable task distribution system. Method 500 may be performed using a computerized system, such as illustrated in FIG. 3 or a physical embodiment, such as illustrated in FIG. 2, which requires no computerization.

At block 510, an action plan grid may be created. This grid may include printed columns and rows that define multiple grid cells. At block 520, various initiatives may be defined on the action plan grid, such as by being written directly on or printed on the grid. For each initiative, one or more project tasks may also be defined. Each of these project tasks may be included in the same row as the linked initiative. Further, for each initiative, a priority may be assigned using either a physical priority card or a virtual priority card. These priority cards may be rearrangeable such that the priorities of different initiatives may be changed. The initiatives and project tasks may be added directly to the action plan grid, such as by permanently printing the initiatives and project tasks onto the grid.

At block 530, for each of the project tasks defined at block 520, an associated project task card may be created that indicates the same project task identifier and project task name. The project task cards created at block 530 may be matched in size to the associated project task cell of the action plan grid. The color of the project task cards may be selected based on a category of the project task (e.g., systems engineering, software engineering, bug repair, hardware updates). At block 540, these created project cards may be overlaid onto the matching project task of the action plan grid. In a physical embodiment, these project task cards may be physically affixed using some form of fastener, such as a removable adhesive, to cause the project task cards to stick over the associated project task cell of the action plan grid. In a computerized embodiment, a virtual project card may be represented on the action plan grid such as to give an impression that the virtual project card is overlaying an underlying project task cell.

Following block 40, each project task on the action plan grid may be overlaid by an associated project task card (or at least virtually appear to be overlaid by a virtual task card). Following block 540, assignment of the project tasks may be ready to be performed, which may be performed in accordance with method 600.

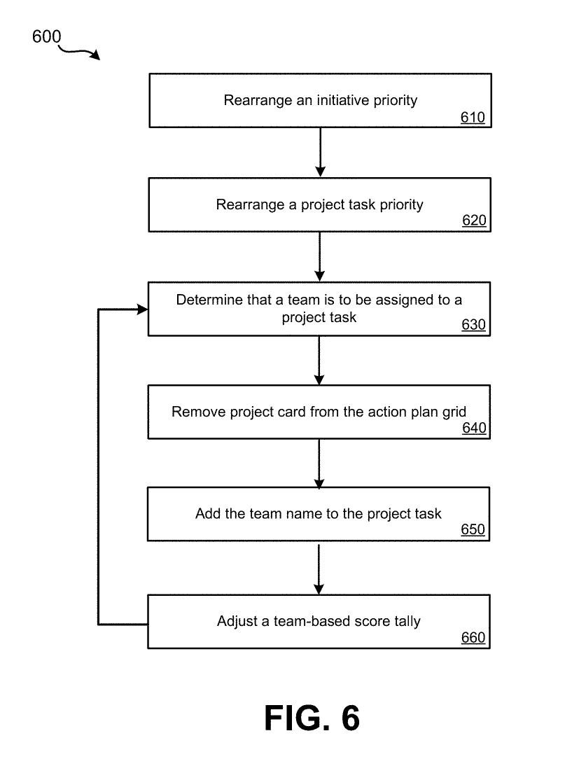

FIG. 6 illustrates an embodiment of a method for using a rearrangeable task distribution system. Method 600 may be performed using a computerized system, such as illustrated in FIG. 3 or a physical embodiment, such as illustrated in FIG. 2, which requires no computerization. At block 610, during a meeting of multiple teams or the representatives of multiple teams, the priority of various initiatives may be rearranged. Such rearranging of initiative priorities may be performed by rearranging the position of initiative priority cards in a physical embodiment or virtual initiative priority cards in a computerized embodiment.

At block 620, the priority of project tasks that went with the various initiatives may be rearranged. If the project tasks have already been written directly onto the action plan grid, a separate identifier may be used to indicate priority for the various project tasks for a given initiative. For example a priority score assigned to each project task may be updated.

At block 630, it may be determined to which team a particular project task is to be assigned. It may be required that the team reside within the department indicated on the project task card or underlying project task cell. In other embodiments, the department indicator may not be used. Once a team has been selected, the project card may be removed from the action plan grid at block 640 and provided to the team to which the project task has been assigned. At block 650, the team name to which the project task has been assigned may be added to the underlying project task cell of the action plan grid.

At block 660, a team-based score tally may be adjusted based on that team being assigned a particular project task. The team-based score tally may indicate an estimated level of effort required to complete the particular project task. This team-based score tally may be used to compare the relative workloads of different project teams to ensure that the workload is properly balanced. If a computerized embodiment is being used, the tally may be presented to each team or possibly only to the administrator or manager using a lead client system, such as lead client system 335. Blocks 630 through 660 may repeat as many times as necessary such that each project task that is to be assigned gets assigned to a particular team.

The methods, systems, and devices discussed above are examples. Various configurations may omit, substitute, or add various procedures or components as appropriate. For instance, in alternative configurations, the methods may be performed in an order different from that described, and/or various stages may be added, omitted, and/or combined. Also, features described with respect to certain configurations may be combined in various other configurations. Different aspects and elements of the configurations may be combined in a similar manner. Also, technology evolves and, thus, many of the elements are examples and do not limit the scope of the disclosure or claims.

Specific details are given in the description to provide a thorough understanding of example configurations (including implementations). However, configurations may be practiced without these specific details. For example, well-known circuits, processes, algorithms, structures, and techniques have been shown without unnecessary detail in order to avoid obscuring the configurations. This description provides example configurations only, and does not limit the scope, applicability, or configurations of the claims. Rather, the preceding description of the configurations will provide those skilled in the art with an enabling description for implementing described techniques. Various changes may be made in the function and arrangement of elements without departing from the spirit or scope of the disclosure.

Also, configurations may be described as a process which is depicted as a flow diagram or block diagram. Although each may describe the operations as a sequential process, many of the operations can be performed in parallel or concurrently. In addition, the order of the operations may be rearranged. A process may have additional steps not included in the figure. Furthermore, examples of the methods may be implemented by hardware, software, firmware, middleware, microcode, hardware description languages, or any combination thereof. When implemented in software, firmware, middleware, or microcode, the program code or code segments to perform the necessary tasks may be stored in a non-transitory computer-readable medium such as a storage medium. Processors may perform the described tasks.

Having described several example configurations, various modifications, alternative constructions, and equivalents may be used without departing from the spirit of the disclosure. For example, the above elements may be components of a larger system, wherein other rules may take precedence over or otherwise modify the application of the invention. Also, a number of steps may be undertaken before, during, or after the above elements are considered.

What is claimed is:

1. A method for creating a physical action plan, the method comprising:
creating a physical grid comprising a plurality of rows and a plurality of columns such that the plurality of rows and the plurality of columns define a plurality of cells, wherein:
the plurality of columns of the physical grid comprises a first column indicative of a plurality of initiatives, wherein each initiative comprises multiple project tasks;
the plurality of columns of the physical grid comprises a second column indicative of a ranking of the plurality of initiatives;
defining, on the physical grid, a plurality of project tasks for at least some cells of the plurality of cells;
creating a plurality of project task cards, wherein:
each project task card of the plurality of project task cards is attachable to and removable from the physical grid;
each project task card of the plurality of project task cards is sized to match a size of a cell size of the plurality of cells; and
each project task card of the plurality of project task cards indicates a different project task of the plurality of project tasks; and
attaching the plurality of project task cards to the physical grid such that each project task card of the plurality of project task cards is attached to and overlays a cell of the physical grid, wherein the project task of the project task card and the project task of the cell match.

2. The method for creating the physical action plan of claim 1, further comprising:
adding a team identifier to a project task card of the plurality of project task cards;
adding the team identifier to a cell of the physical grid over which the project task card was attached; and
removing the project task card from the physical grid.

3. The method for creating the physical action plan of claim 1, further comprising:
altering each column in which a project task card is attached to identify a priority of a project task of the project task card relative to other project tasks within a same row of the plurality of rows.

4. The method for creating the physical action plan of claim 1, wherein creating the plurality of project task cards comprises selecting a color for each project task card of the plurality of project task cards based on a category of a project task of the project task card.

5. The method for creating the physical action plan of claim 1, further comprising:
creating a plurality of initiative priority cards, wherein:
each initiative priority card of the plurality of initiative priority cards is removable from and attachable to the physical grid;
each initiative priority card of the plurality of initiative priority cards is sized to match a cell size of the second column; and
each initiative priority card of the plurality of initiative priority cards indicates a different priority.

6. The method for creating the physical action plan of claim 5, further comprising:
altering each row of the plurality of rows in which an initiative priority card is located to identify a priority of an initiative of the plurality of initiatives relative to other initiatives of the plurality of initiatives.

7. The method for creating the physical action plan of claim 1, wherein the plurality of project task cards each comprise a removable adhesive.

8. An action plan management system, comprising:
a physical grid comprising a plurality of rows and a plurality of columns that define a plurality of cells, wherein:
the plurality of columns of the physical grid comprises a first column indicative of a plurality of initiatives;
the plurality of columns of the physical grid comprises a second column indicative of a ranking of the plurality of initiatives;
the plurality of columns of the physical grid comprises multiple columns indicative of projects;
within the multiple columns indicative of projects, each cell of the plurality of cells corresponds to a particular project; and
the plurality of rows comprises multiple rows in which each row relates one or more projects with an initiative of the plurality of initiatives; and
a plurality of project task cards, wherein:
each project task card of the plurality of project task cards is removable from and re-attachable to the physical grid;
each project task card of the plurality of project task cards is sized to match a size of the plurality of cells; and
each project task card of the plurality of project task cards indicates a particular project task that matches an indication of the particular project task indicated on the physical grid in the cell to which the project task card is removably attached and overlays.

9. The action plan management system of claim 8, wherein:
a team identifier is present on a project task card of the plurality of project task cards; and
the team identifier is present on the cell of the physical grid over which the project task card was attached.

10. The action plan management system of claim 8, wherein:
each column of the multiple columns in which a project task card is organized to identify a priority of a project task of the project task card relative to other project tasks within a same row of the plurality of rows.

11. The action plan management system of claim 8, wherein the plurality of project task cards are colored based on a category of a project task of each project task card.

12. The action plan management system of claim 8, further comprising:
a plurality of initiative priority cards, wherein:
each initiative priority card of the plurality of initiative priority cards is removable from and attachable to the physical grid;
each initiative priority card of the plurality of initiative priority cards is sized to match a cell size of the second column; and
each initiative priority card of the plurality of initiative priority cards indicates a different priority.

13. The action plan management system of claim 8, wherein the plurality of project task cards each comprise a removable adhesive.

14. An action plan management apparatus, comprising:
a grid means comprising a plurality of rows and a plurality of columns that define a plurality of cells, wherein:
the plurality of columns of the grid means comprises a first column indicative of a plurality of initiatives;
the plurality of columns of the grid means comprises a second column indicative of a ranking of the plurality of initiatives;
the plurality of columns of the grid means comprises multiple columns indicative of projects;
within the multiple columns indicative of projects, each cell of the plurality of cells corresponds to a particular project; and
the plurality of rows comprises multiple rows in which each row relates one or more projects with an initiative of the plurality of initiatives; and
a plurality of project task means, wherein:
each project task means of the plurality of project task means is presentable separate from the grid means;
each project task means of the plurality of project task means is sized to match a size of the plurality of cells; and
each project task means of the plurality of project task means indicates a particular project task that matches an indication of the particular project task indicated on the grid means in the cell to which the project task means overlays.

15. The action plan management apparatus of claim 14, further comprising:
a team identifier means present on a project means of the plurality of project task means; and
a corresponding team identifier means being present on a cell of the grid means on which the project means is presented.

16. The action plan management apparatus of claim 14, further comprising:
means for altering each column of the multiple columns in which a project means is present to identify a priority of a project task of the project task means relative to other project tasks within a same row of the plurality of rows.

17. The action plan management apparatus of claim 14, wherein creating the plurality of project task means comprises selecting a color for each project task means of the plurality of project task means based on a category of a project task of the project task means.

18. The action plan management apparatus of claim 14, further comprising:
a plurality of initiative priority means, wherein:
each initiative priority means of the plurality of initiative priority means are presentable on the grid means;
each initiative priority means of the plurality of initiative priority means is sized to match a cell size of the second column; and
each initiative priority means of the plurality of initiative priority means indicates a different priority.

19. The action plan management apparatus of claim 18, further comprising:
means for altering each row of the plurality of rows in which an initiative priority means identifies a priority of an initiative of the plurality of initiatives relative to other initiatives of the plurality of initiatives.

20. The action plan management apparatus of claim 14, wherein the plurality of project task means each comprise a removable adhesive.
